(19) United States
(12) Patent Application Publication
(10) Pub. No.: US 2025/0165880 A1
(43) Pub. Date: May 22, 2025

(54) SOURCE-AGNOSTIC DATA GENERATION FOR ENTERPRISE RESOURCE PLANNING

(71) Applicant: PwC Product Sales LLC, New York, NY (US)

(72) Inventors: Yuji Shane KONDO, Danville, CA (US); Michael VOGT, Sugar Grove, IL (US)

(73) Assignee: PwC Product Sales LLC, New York, NY (US)

(21) Appl. No.: 18/515,903

(22) Filed: Nov. 21, 2023

(51) Int. Cl. G06Q 10/0631; G06F 16/215; G06F 16/25

(52) U.S. Cl. CPC G06Q 10/0631; G06F 16/215; G06F 16/254

(57) ABSTRACT

Described herein are methods, systems, and computer-readable mediums for generating source-agnostic data for enterprise resource planning. In some embodiments, source-specific data, received from a data source. The source-specific data may be structured using a data formatting protocol associated with the data source. A source-canonical transformation accelerator may be accessed from a transformation database. The source-canonical transformation accelerator may be configured to transform the source-specific data into source-agnostic data structured using a source-agnostic data formatting protocol. The source-agnostic data may be generated using the source-canonical transformation accelerator based on the source-specific data.

### FIELD

This application relates generally to a transformation accelerator for generating source-agnostic data. In particular, the source-agnostic data can be used to reduce load and processing times for enterprise resource planning (ERP).

### BACKGROUND

Enterprise systems enable users to analyze, process, and share data across entities to improve logistical operations. These enterprise system implement software, referred to as enterprise resource planning (ERP), that aid in managing the operations. As the accessibility and capabilities of cloud-computing services continues to increase, clients are increasingly opting to migrate their enterprise systems to cloud-computing services. This migration naturally warrants a re-configuration of the client's analytics platform to harness the cloud-computing service's full range of capabilities. However, this reconfiguring requires a quick ingestion of the client's data (e.g., master data, transactional data, operational data, third-party data, and the like) from a large number of data source, each with source-specific data structured with a source-specific format. Therefore, the ingestion and transformation of the client's data is a bottleneck for successful development and deployment of the client's enterprise systems to a cloud-computing service.

### SUMMARY

Described herein are techniques for generating source-agnostic data for enterprise resource planning. The source-agnostic data can be quickly ingested by one or more enterprise systems operating in a cloud-computing environment, thereby removing the bottleneck traditionally experienced when migrating enterprise systems to cloud-computing environments. In one or more examples, a source-canonical transformation accelerator may be developed to transform source-specific data into source-agnostic data. The source-canonical transformation accelerator may be configured to analyze the source-specific data associated with each data source and identify specific types of metadata stored therein. The extracted metadata values may then be used to generate the source-agnostic data, which removes the source-specific formatting used to structure each instance of source-specific data. Thus, the source-agnostic data enables clients to quickly implement their enterprise systems, regardless of the data source, in cloud-computing environments, thereby minimizing uplink times and operational perturbations.

In some embodiments, a method is provided for generating source-agnostic data for enterprise resource planning. The method may include: receiving, from a data source, source-specific data structured using a data formatting protocol associated with the data source; accessing, from a transformation database, a source-canonical transformation accelerator configured to transform the source-specific data into source-agnostic data structured using a source-agnostic data formatting protocol; and generating, using the source-canonical transformation accelerator, the source-agnostic data based on the source-specific data.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed can be resorted to by those skilled in the art, and that such modifications and variations are considered to be within the scope of this invention as defined by the appended claims.

### BRIEF DESCRIPTION OF THE DRAWINGS

FIG. 1 illustrates an example system for generating source-agnostic data for enterprise resource planning, in accordance with various embodiments.

FIG. 2 illustrates an example table including first source-specific data from a first data source and second source-specific data from a second data source, in accordance with various embodiments.

FIG. 3 illustrates a standard architecture for ingesting, processing, and storing source-specific data for end-user analytics, in accordance with various embodiments.

FIG. 4 illustrates an example of a metadata-driven architecture 400 configured to process data for end-user analytics, in accordance with various embodiments.

FIG. 5 illustrates an example of transformation logic, in accordance with various embodiments.

FIG. 6A illustrates an example process for generating source-agnostic data using a source-canonical transformation accelerator, in accordance with various embodiments.

FIG. 6B illustrates an example table including source-agnostic data and corresponding first source-specific data from a first data source and second source-specific data from a second data source, in accordance with various embodiments.

FIG. 7 illustrates an example process for generating source-specific data from source-agnostic data using a canonical-source transformation accelerator, in accordance with various embodiments.

FIG. 8 illustrates an example of an ERP scheduling framework, in accordance with various embodiments.

FIG. 9 illustrates a flowchart of an example method for generating source-agnostic data for enterprise resource planning, in accordance with various embodiments.

FIG. 10 illustrates an example computer system used to implement some or all of the techniques described herein.

### DETAILED DESCRIPTION

Described herein are systems, methods, and computer-readable mediums for generating source agnostic data used for enterprise resource planning (ERP). In particular, a metadata-driven data integration platform is described herein that facilitates the generation of the source-agnostic data. The metadata-driven integration platform may leverage pipelines that are implemented as reusable software modules, APIs, and/or metadata, to ingest, process, and store data for end-user analytics. The metadata-driven integration platform may be capable of ingesting new data sets from a large number of different data sources (e.g., 10 or more data sources, 100 or more data sources, 1,000 or more data sources, and the like) using a minimal number of pipelines (e.g., 3 pipelines). The metadata-driven integration platform may be configured to transform the data from the different data sources into a source-agnostic format such that the various data can be blended and processed together. By blending the data, the metadata-driven integration platform can leverage source-agnostic models for end-user analytics across different enterprise systems and/or cloud-computing services.

As described herein, a “data lake” refers to a data storage system that stores semi-structured data in its native format. As described herein, a data mart” refers to a data storage system that stores data in an entity-specific format.

In the last decade, more and more companies are choosing to modernize their enterprise software solutions, including moving to cloud-computing environments. With this modernization, previously deployed analytics platforms also need to be updated. This leads to a technical challenge in that a custom solution needs to be built out for every company.

To overcome the technical problems described herein, technical solutions have been developed that allow master (reference) data, transactional data, operational data, third-party data, and/or other types of data, to all be ingested across a variety of different source systems (e.g., SAP, Oracle). In particular, source-specific data may be transformed into source-agnostic data, which enables pipelines to be reused for a large number of different data sources. The transformation process may be facilitated by a source-canonical transformation accelerator, which is capable of ingesting source-specific data and outputting source-agnostic data, which can directly be analyzed using one or more analytics platforms.

Some examples of master data include parties and products. For example, one transaction may be a product order, which can include a product type and a product quantity (e.g., a purchase for 5 widgets). The master data may store the parties involved in this transaction (e.g., seller party, buyer party), the product type, the product quantity, and/or other data.

The transactional data may include information about the transaction, which may be stored as two forms of transactions: a sales transaction and a financial transaction. The sales transactions indicates the product sale, such as how many of a given product were included in the transaction, whereas the financial transaction may indicate information around the purchase, such as how much the product cost, how much was received from a party for the product, tax applied to the transaction, and the like.

The operational data may include information about the product and/or other products. For example, the operational data may indicate a current quantity of the product in inventory. The operational data may also comprise trigger conditions, indicating when particular actions are to be performed (e.g., when to restock a product) based on the current quantity reaching a threshold quantity.

The third party data may include data that is procured from a third party data source. The third party data may, for example, include data that is obtained from a party that facilitated the transaction (e.g., a retailor that sold the product). This third party data may be used to cross-check transactions with SKUs, and perform other checks, and/or provide other insights for a client and/or company.

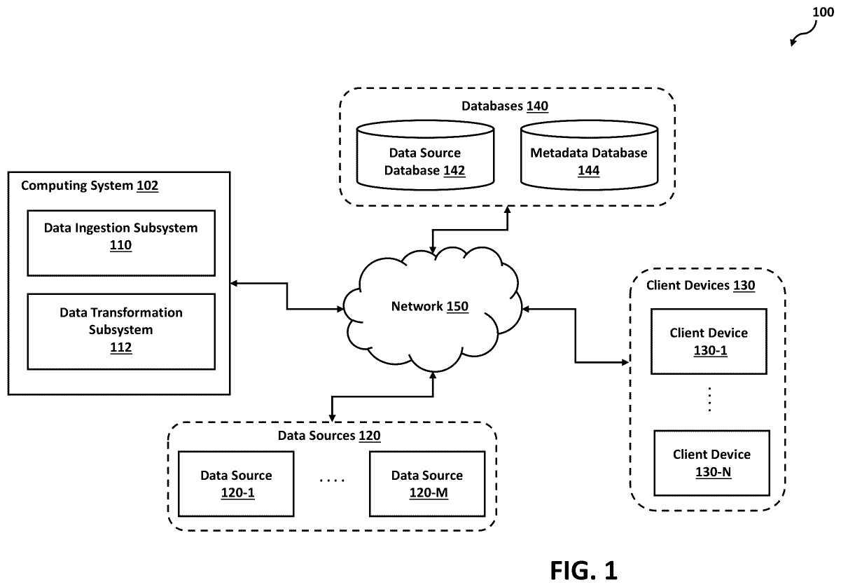

FIG. 1 illustrates an example system 100 for generating source-agnostic data for enterprise resource planning, in accordance with various embodiments. System 100 may include a computing system 102, data sources 120-1 to 120-M (e.g., collectively referred to as “data sources 120”), client devices 130-1 to 130-N (e.g., collectively referred to as “client devices 130”), databases 140 (e.g., data source database 142, metadata database 144, metadata database 144), or other components. In some embodiments, components of system 100 may communicate with one another using network 150, such as the Internet.

Client devices may be capable of communicating with one or more components of system 100 via network 150 and/or via a direct connection. Client device 130 may refer to a computing device configured to interface with various components of system 100 to control one or more tasks, cause one or more actions to be performed, or effectuate other operations. For example, client device 130 may be configured to provide inputs to computing system 102 and/or data sources 120 via network 150. Example computing devices that client devices 130 may correspond to include, but are not limited to, which is not to imply that other listings are limiting, desktop computers, servers, mobile computers, smart devices, wearable devices, cloud computing platforms, or other client devices. In some embodiments, each client device 130 may include one or more processors, memory, communications components, display components, audio capture/output devices, image capture components, or other components, or combinations thereof. Each client device 130 may include any type of wearable device, mobile terminal, fixed terminal, or other device.

Data sources 120 may include any number of data sources, and data sources 120 may comprise a variety of different types of data sources. As an example, data sources 120 may include one or more software-as-a-service (SaaS) sources, one or more files as sources, one or more information-of-things (IoT) devices as sources, one or more events as sources, one or more applications as sources, one or more databases (e.g., databases 140) as sources, one or more logs as sources, one or more streaming sources, or other sources, or combinations thereof. In one or more examples, data sources 120 may include M different data sources. M may be any integer value such as, for example, 10 or more, 100 or more, 1,000 or more, 10,000 or more, and the like. In one or more examples, two or more of data sources 120 may have a same format (e.g., two databases as two separate sources).

It should be noted that, while one or more operations are described herein as being performed by particular components of computing system 102, data sources 120, and/or client devices 130, those operations may, in some embodiments, be performed by other components of system 100. As an example, while one or more operations are described herein as being performed by components of computing system 102, those operations may, in some embodiments, be performed by components client devices 130. It should also be noted that, although some embodiments are described herein with respect to machine learning models, other prediction models (e.g., statistical models or other analytics models) may be used in lieu of or in addition to machine learning models in other embodiments (e.g., a statistical model replacing a machine-learning model and a non-statistical model replacing a non-machine-learning model in one or more embodiments). Furthermore, although a single instance of computing system 102 is depicted within system 100, additional instances of computing system 102 may be included.

Computing system 102 may include a data ingestion subsystem 110, a transformation selection subsystem 112, or other components. Each of data ingestion subsystem 110 and transformation selection subsystem 112 may be configured to communicate with one another, one or more other devices, systems, servers, etc., using one or more communication networks (e.g., the Internet, an Intranet). System 100 may also include one or more databases 140 (e.g., data source database 142, metadata database 144, metadata database 144) used to store data for use by one or more components of system 100. This disclosure anticipates the use of one or more of each type of system and component thereof without necessarily deviating from the teachings of this disclosure. Although not illustrated, other intermediary devices (e.g., data stores of a server connected to computing system 102) can also be used.

ERP comprises software solutions that enables various different data to be retrieved, compiled, and viewed in a simplified manner. ERP software solutions may be capable of managing various aspects of a company's operations, including, but not limited to, accounting (e.g., accounts payable (A/P), accounts receivable (A/R)), budging, pricing, human resources, marketing, artificial intelligence and machine learning, and the like. Some example ERP software solutions include SAP and Oracle, which may provide centralized databases for storing a company's data. Although the various ERP software solutions can store similar data, they may be operated using different languages and/or have different structures. As an example, SAP's ERP software solution may run in a first language (e.g., ABAP) whereas Oracle's ERP software solution may be accessed using a second language (e.g., SQL).

Previously, companies operating their respective ERP software solutions in a local computing environment. However, as cloud-computing environments have expanded in capabilities and decreased in price, more and more companies have opted to migrate from their legacy-computing environments to cloud-computing environments. This can raise issues when it comes time to ingest the company's original data, as different existing ERP software solutions can operate in different languages (e.g., SAP running in ABAP, Oracle running in SQL). Thus, described herein are techniques for generating source-agnostic data from source-specific data. The source-agnostic data can then be used by the company on their selected cloud-computing service, harnessing the full suite of software tools available with cloud-computing.

In some embodiments, data ingestion subsystem 110 may be configured to receive, from a data source, source-specific data structured using a data formatting protocol associated with the data source. In one or more examples, the data source may comprise a first data source of a plurality of data sources 120. Each of data sources 120 may include data structured using a corresponding source-specific data formatting protocol. Some of data sources 120 may have a same or similar format as other data sources 120. In one or more examples, data sources 120 may include one or more enterprise resource planning (ERP) sources, one or more external sources, one or more internal sources, one or more SaaS sources, or other sources. Depending on the data source, the source-specific data may be received in a particular format, such as an SFTP file transfer, a blob event, a batch event, an API call/streaming event, and the like. In some examples, data sources 120 may include at least ten data sources, at least one hundred data sources, at least one thousand data sources, or other quantities of data sources.

In some embodiments, data ingestion subsystem 110 being configured to receive the source-specific data may comprise data ingestion subsystem 110 receiving an event notification indicating that the source-specific data is available. In one or more examples, a stateful logic application of data ingestion subsystem 110 may be configured to generate time events at a predefined, and optionally configurable, cadence (e.g., every few minutes). Based on the event type, a list of pipelines to be triggered may be determined, and the determined pipelines may indicate which loads are to be triggered.

In some embodiments, data ingestion subsystem 110 may be configured to use a service bus queue to broker messages between the event grid topic and the cloud-computing service function application. The cloud-computing service function application may be used to evaluate the dependencies of the data before sending a list of events to the event grid. Data ingestion subsystem 110 may be configured to load the source-specific data into a raw data layer of a cloud-computing service based on the event notification being received. For example, the list of dependencies may indicate that the particular event received is subscribed to two pipelines, one at a datalake (e.g., raw) layer and one at a datamart (e.g., canonical) layer. Furthermore, these pipelines at load the data to the respective layer using different scheduling master pipelines.

In one or more examples, the cloud-computing service may comprise a first cloud-computing service of a plurality of cloud-computing services. The cloud-computing services may be offered by different providers. For example, Amazon, Microsoft, and Google each offer cloud-computing services. Some cloud-computing services may provide infrastructure-as-a-service (IaaS), platform-as-a-service (PaaS), software-as-a-service (SaaS), or other features.

Each of the cloud-computing services may have/implement a different infrastructure. While the cloud-computing services may have similarities in how they operate, the way that data is read-in and processed can differ from provider to provider.

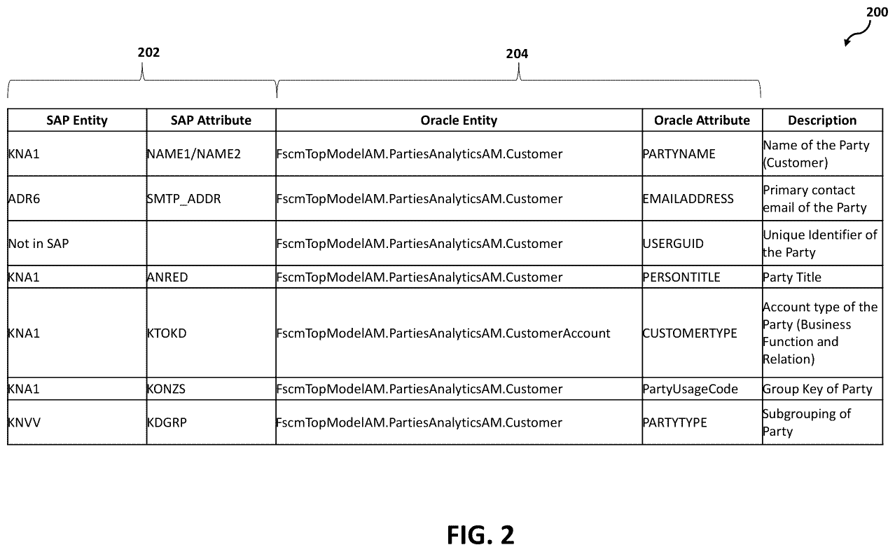

In some embodiments, different cloud-based data warehouses may store data in different manners, however some may also include common features. For example, many cloud-based data warehouse platforms may include columnar storage and massively parallel processing (MPP) architecture. As an example, with reference to FIG. 2, table 200 includes first source-specific data 202 (e.g., “SAP Entity,” “SAP Attribute”) from a first data source (e.g., one of data sources 120) and second source-specific data 204 (e.g., “Oracle Entity,” “Oracle Attribute,” “Oracle Data Type”) from a second data source (e.g., a different one of data sources 120). While first source-specific data 202 and second source-specific data 204 may represent the same data, the data formatting protocol used by the corresponding first source and the second from which they are obtained, and the identifiers used to describe the data, may differ. For instance, first source-specific data 202 may include the entities “KNA1,” “ADR6,” “KNVV,” or others. First source-specific data 202 may further include attributes, such as “NAME1/NAME2,” “SMTP ADDR,” “ANRED,” “KTOKD,” “KNOZS,” “KDGRP,” or others. Second source-specific data 204 may include the entities, “FscmTopModelAM.PartiesAnalyticsAM.Customer,” “FscmTopModelAM.PartiesAnalyticsAM.CustomerAccount,” or others. Second source-specific data 204 may further include attributes, such as “PARTYNAME,” “EMAILADDRESS,” “USERGUID,” “PERSONTITLE,” “CUSTOMERTYPE,” “PartyUsageCode,” “PARTYTYPE,” or others.

As seen in FIG. 2, table 200 further includes a description column indicating what the like attributes and entities refer to in both first source-specific data 202 and second source-specific data 204. For example, the entity “KNA1” in first source-specific data 202 having attribute “NAME1/NAME2” and the entity “FscmTopModelAM.PartiesAnalyticsAM.Customer” in a second source-specific data 204 having the attribute “PARTYNAME,” may both represent a name of a party involved in a particular transaction (e.g., a customer). Thus, even though the data is structured using different data formatting protocols, the data represents the same information.

In some embodiments, one or more entities in one source system data may not have a known counterpart in one or more other data source's data formatting protocols. For example, second source-specific data 204 may include the entity “FscmTopModelAM.PartiesAnalyticsAM.Customer,” having the attribute “USERGUID.” This entity refers to a unique identifier of a party involved in a transaction. However, no corresponding entity and/or attribute may exist in first source-specific data 202.

In some embodiments, data ingestion subsystem 110 may be configured to take the tables, such as those illustrated in FIG. 2, and create one or more solutions tables in a cloud-computing environment from the respective data sources 120. The created solutions tables, which may be used to execute queries for analytics, may differ across different cloud-computing service providers. Data ingestion subsystem 110 may be configured to identify the cloud-computing environment and determine the corresponding data lake architecture. Even though the architectures differ across the cloud-computing environments, the solutions tables remain structurally the same or similar.

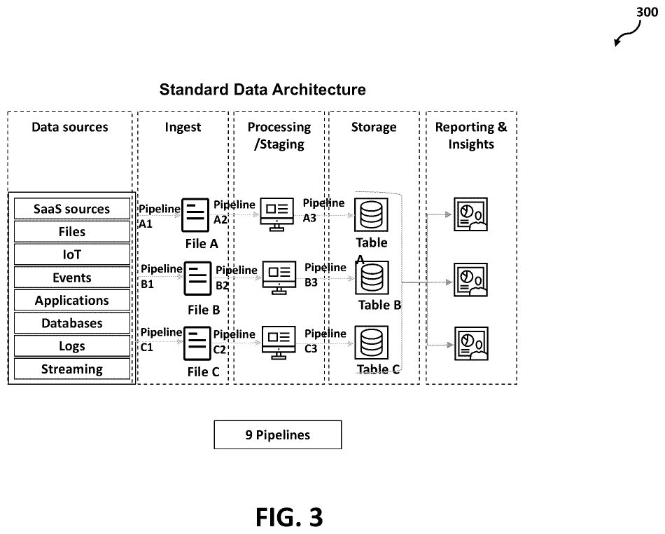

FIG. 3 illustrates a standard architecture 300 for ingesting, processing, and storing source-specific data for end-user analytics, in accordance with various embodiments. Standard architecture 300 may include data sources (e.g., such as data sources 120 of FIG. 1). For example, source-specific data (e.g., tables) may be obtained from one or more of data sources 120 (e.g., SaaS sources, files, IoT devices, events, applications, databases, logs, streamlining). The source-specific data may be processed by multiple pipelines in standard architecture 300. In particular, through the ingestion, processing/staging, and storage layers of standard architecture 300, for every T instances of source-specific data (e.g., tables that are received), standard architecture 300 implements 3T pipelines. In other words, for each instance of source-specific data that is received, a separate pipeline may be used for each of the ingestion, processing/staging, and storage layers. In some embodiments, the transformation process of standard architecture 300 may be configured to execute an extract pipeline (e.g., “Pipeline A1,” “Pipeline B1,” “Pipeline C1”), a transformation pipeline (e.g., “Pipeline A2,” “Pipeline B2,” “Pipeline C2”), and a load pipeline (e.g., “Pipeline A3,” “Pipeline B3,” “Pipeline C3”) for each stage of an extract-transform-load (ELT) process. For each instance of source-specific data received will be processed using a separate set of pipelines (e.g., “Pipeline A1” to “Pipeline A2” to “Pipeline A3”).

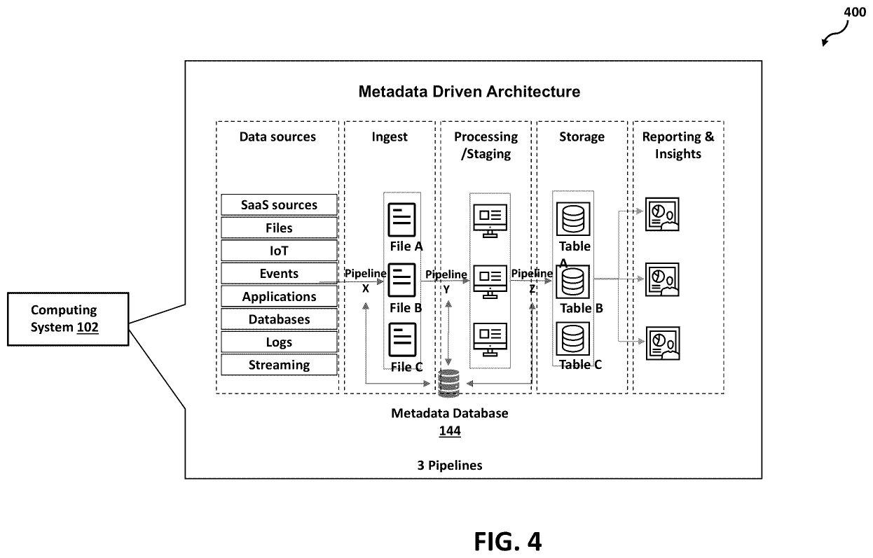

FIG. 4 illustrates an example of a metadata-driven architecture 400 configured to process data for end-user analytics, in accordance with various embodiments. In some embodiments, metadata-driven architecture 400 may be implemented by computing system 102 of FIG. 1. Metadata-driven architecture 400 may include similar layers as standard architecture 300 of FIG. 3. For example, metadata-driven architecture 400 may include data sources (e.g., such as data sources 120 of FIG. 1). For example, source-specific data (e.g., tables) may be obtained from one or more of data sources 120 (e.g., SaaS sources, files, IoT devices, events, applications, databases, logs, streamlining).

The source-specific data may be processed by three pipelines in metadata-driven architecture 400. In particular, through the ingestion, processing/staging, and storage layers of metadata-driven architecture 400, regardless of the number T of instances of source-specific data (e.g., tables) that are received, metadata-driven architecture 400 implements 3 pipelines. In some embodiments, source-canonical transformation accelerators may be configured to execute an extract pipeline (e.g., “Pipeline X”), a transformation pipeline (e.g., “Pipeline Y”), and a load pipeline (e.g., “Pipeline Z”) for each stage of an extract-transform-load (ELT) process. In one or more examples, each of the extract pipeline, the transformation pipeline, and the load pipeline may be controlled by the plurality of metadata tables stored in metadata database 144. Implementing the aforementioned process using the plurality of metadata tables provides a technical improvement over existing data processing systems by reducing a number of pipelines used by the ERP to a single instance of each of the extract pipeline, the transformation pipeline, and the load pipeline.

Transformation logic (e.g., source-canonical transformation accelerators) may be stored in a metadata database 144. The transformation logic may include rules for transforming source-specific data into source-agnostic data. These rules may enable the source-specific data to be transformed from being structured using a data formatting protocol associated with a given data source to being structured using a source-agnostic data formatting protocol. The transformation logic may be configured to perform such transformations based on the discovery that although the attributes can differ between data sources, the data structures are the same. Each of the pipelines employed by standard architecture 300 may be configured to interpret the metadata in a same or similar manner despite the implementations being different. Therefore, the transformation logic may enable data to be immediately transformed from its source-agnostic format to one or more other data formatting protocols associated with other data sources 120.

In some embodiments, data ingestion subsystem 110 may be configured to execute a set of metadata classification rules to the source-specific data. The source specific data may be structured using a data formatting protocol associated with a particular one of data sources 120 from which the source-specific data originated. Depending on the data source, different formatting protocols may be used. For example, data originating from an SAP source may have its data formatted using ABAP whereas data originating from an Oracle source may have its data formatted using SQL. Therefore, even though first source-specific data from a first data source and second source-specific data from a second data source may include the same data, the structure of that data, and the rules which are used to extract, analyze, and present the data, may vastly differ.

The metadata classification rules implemented by data ingestion subsystem 110 may be configured to identify one or more types of metadata within the source-specific data. As an example, one data source may correspond to an ERP software service configured to store data within a set of tables, and each table may include one or more data fields. For example, an address table in this ERP software service may include columns representing fields (e.g., “CLIENT,” “ADDRNUMBER,” “TITLE,” NAME1,” and the like), data elements (e.g., “MANDT,” “AD ADDRNUM,” “AD_TITLE,” “AD_NAME1,” and the like), data types (e.g., “CLNT,” “CHAR,” “DATS,” and the like), and other information.

In some embodiments, data ingestion subsystem 110 may be configured to identify the data source associated with the received source-specific data and identify a transformation accelerator for transforming the source-specific data into source-agnostic data. Using the metadata included within the source-specific data, data ingestion subsystem 110 may retrieve a particular source-canonical transformation accelerator trained to identify source-specific data structured using a data formatting protocol associated with the source-specific data's data source and transform the source-specific data into source-agnostic data structured using a source-agnostic data formatting protocol. For example, the rules stored in metadata database 144 may specify how the corresponding source-specific data should be transformed into source-agnostic data.

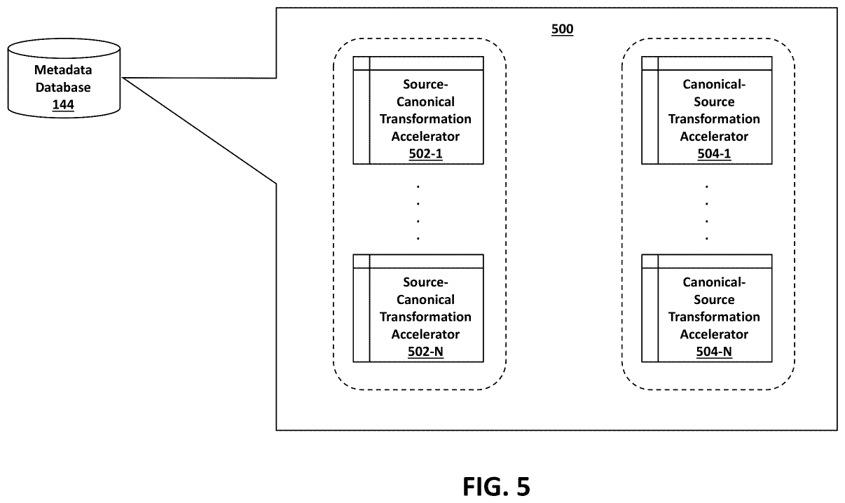

As an example, with reference to FIG. 5, metadata database 144 may include transformation logic 500. In some embodiments, transformation logic 500 may include transformation accelerators comprising rules and mappings for transforming source-specific data into source agnostic data. In one or more examples, transformation logic 500 may include source-canonical transformation accelerators 502-1 to 502-N (collectively “source-canonical transformation accelerators 502”). Each of source-canonical transformation accelerator 502 may be designed to transform source-specific data structured using a data formatting protocol associated with a corresponding data source into source-agnostic data structured using a source-agnostic data formatting protocol, which may enable end-user analytics, such as machine learning/AI and/or dashboards, to be easily harnessed.

Transformation logic 500 may also include transformation accelerators comprising rules and mappings for transforming source-agnostic data into source-specific data. In one or more examples, transformation logic 500 may include canonical-source transformation accelerators 504-1 to 504-N (collectively “canonical-source transformation accelerators 504”). Each of canonical-source transformation accelerator 504 may be designed to transform source-agnostic data structured using a source-agnostic data formatting protocol into source-specific data structured using a data formatting protocol associated with a corresponding data source. By enabling the source-agnostic data to be transformed into a variety of different types of source-specific data (associated with various data sources 120), the data can be stored using various different data sources. For example, data stored using an SAP system can be transformed data stored using an Oracle system.

In one or more examples, the set of metadata classification rules attribute a value to each of the one or more types of metadata based on the source-specific data. For example, using the example above, the value for “AD_NAME1” stored within a given table may be attributed to the corresponding metadata field (e.g., “ADDRNUMBER”).

As a result of the transformation to a source-agnostic format, the data can be used for a variety of purposes. For example, the source-agnostic data may be used to populate one or more dashboards for user consumption. As another example, the source-agnostic data may be input to one or more machine learning models for further end-user analytics. As yet another example, the generated source-agnostic data may be used to generate other source-specific data structured using the data formatting protocols of one or more other data sources 120.

In some embodiments, data ingestion subsystem 110 may be configured to apply one or more data quality rules to the source-specific data. As an example, some data quality rules may include removing leading and/or trailing spaces, converting a date field, standardizing a format of one or more amount fields, checking values, checking for NULL entries, and the like. Data ingestion subsystem 110 may determine whether the data quality rules indicate that the source-specific data has been cleansed. If so, data ingestion subsystem 110 may be configured to store the source-specific data as hybrid-based data within data source database 142. The hybrid data may be stored, for example, as a parquet file, however other file formats may be used. In one or more examples, the hybrid-based data may comprise chunks of columns of data sequentially stored. In one or more examples, each chunk of columns may comprise values for each of the one or more types of metadata. The hybrid-based data may be used when generating the source-agnostic data using the source-canonical transformation accelerator, as detailed below. The hybrid-based data may lead to improved performance when selecting and filtering the data.

In some embodiments, data ingestion subsystem 110 may be configured to analyze a company's enterprise system and perform a gap analysis. The gap analysis may allow data ingestion subsystem 110 to identify any differences between the company's enterprise system and known enterprise systems for which transformation rules exist. In one or more examples, aspects of each company's enterprise system may remain the same (e.g., products, parties, etc.), however some aspects may differ. The gap analysis can identify those differences so that data ingestion subsystem 110 can generate any additional mappings needed to transform the company's data from their enterprise system's format to the source-agnostic format.

In some embodiments, data transformation subsystem 112 may be configured to access, from a metadata database 144, one of source-canonical transformation accelerators 502 configured to transform source-specific data associated with an identified one of data sources 120 into source-agnostic data structured using a source-agnostic data formatting protocol. Source-canonical transformation accelerators 502 may, for example, comprise a plurality of metadata tables storing one or more data schemas, one or more transformation rules, one or more control parameters, error-handling logic, or other information, or combinations thereof.

In some embodiments, data transformation subsystem 112 being configured to generate the source-agnostic data may comprise data transformation subsystem 112 generating, using the source-canonical transformation accelerator, the source agnostic data based on the hybrid-based data. As mentioned above, data quality rules may be applied to the source-specific data. A determination may be made as to whether the data quality rules indicate that the source-specific data has been cleansed. If so, the source-specific data may be stored as hybrid-based data within data source database 142. In one or more examples, the hybrid-based data may comprise chunks of columns of data sequentially stored. In one or more examples, each chunk of columns may comprise values for each of the one or more types of metadata. Data transformation subsystem 112 may subsequently use the hybrid-based data to generate the source-agnostic data using the source-canonical transformation accelerator.

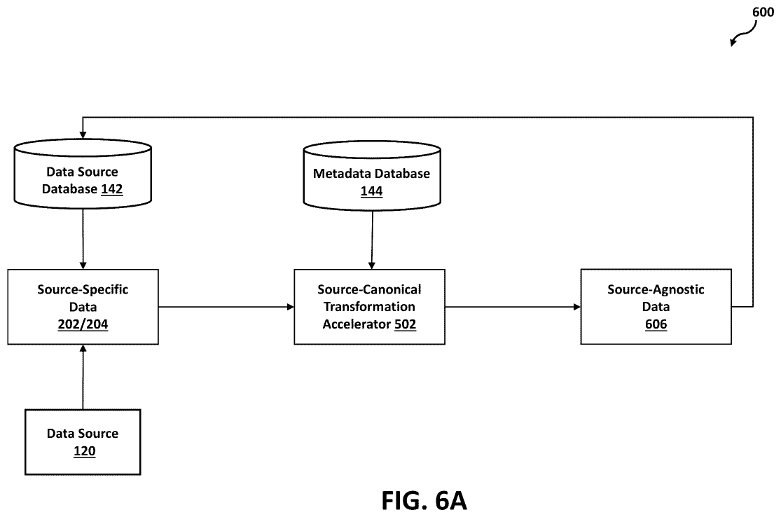

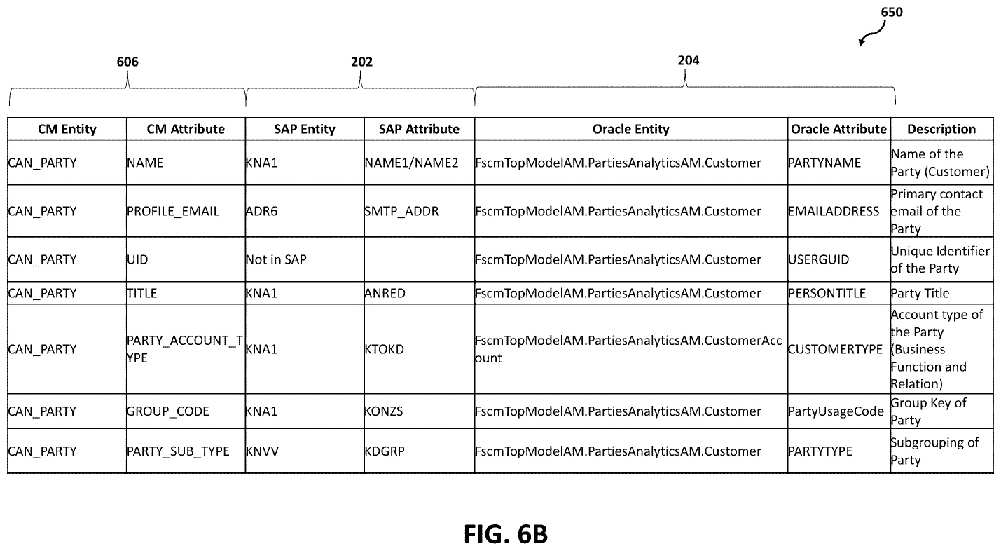

In some embodiments, as seen, for example, with reference to FIG. 6A, data transformation subsystem 112 may be configured to execute one of source-canonical transformation accelerators 502 to generate source-agnostic data 606. In some embodiments, process 600 may include source-specific data, such as source-specific data 202 structured using a data formatting protocol associated with a first data source or source-specific data 204 structured using a data formatting protocol associated with a second data source, being received from the first data source or the second data source (e.g., one of data sources 120) or from data source database 142. The instance of source-canonical transformation accelerators 502 selected from metadata database 144 may depend on the data source associated with the received source-specific data.

In some embodiments, one or more rules and/or mappings associated with selected source-canonical transformation accelerator 502 and stored in metadata database 144 may be executed by data transformation subsystem 112 to generate source-agnostic data 606. As mentioned above, source-agnostic data 606 may be formatted using a source-agnostic data formatting protocol. As an example, with reference to FIG. 6B, table 650 may include source-agnostic data 606, first source-specific data 202, and second source-specific data 204. As illustrated by table 650, the names of the entities may differ even though the actual data may represent the same thing. For example, in first source-specific data 202, the name of a party of a transaction may be referenced via the entity “KNA1,” whereas in second source-specific data 204, the same name of the party of the transaction may be referenced via the entity “FscmTopModelAM.PartiesAnalyticsAM.Customer.” To resolve this discrepancy, source-canonical transformation accelerators 502 may transform first source-specific data 202 and second source-specific data 204 into source-agnostic data 606. Now, instead of referencing to the entities “KNA1” or “FscmTopModelAM.PartiesAnalyticsAM.Customer,” the same data may be referenced using the source-agnostic form: “CAN_PARTY.”

Data transformation subsystem 112 may be configured to access, from metadata database 144, a canonical-source transformation accelerator 504 configured to transform the source-agnostic data into second source-specific data structured using a second data formatting protocol associated with a second data source. In one or more examples, data transformation subsystem 112 may be configured to generate, using the retrieved canonical-source transformation accelerator 504, the second data based on the source-agnostic data (e.g., source-agnostic data 606).

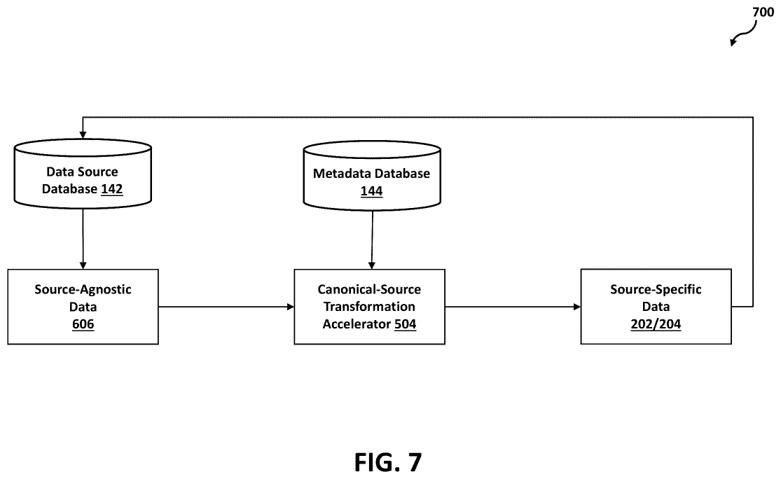

As an example, with reference to FIG. 7, process 700 may include source-agnostic data 606 being retrieved from data source database 142. Source-agnostic data 606 may be transformed, using one of canonical-source transformation accelerators 504 stored in metadata database 144, into source-specific data (e.g., source-specific data 202 or 204). In some embodiments, data ingestion subsystem 110 may be configured to determine which source-specific data formatting protocol source-agnostic data 606 is to be transformed into. Based on the to-be-transformed-into data formatting protocol, data ingestion subsystem 110 may provide an indication to data transformation subsystem 112 of an appropriate canonical-source transformation accelerator 504 to select. The selected canonical-source transformation accelerator 504 may include rules and mappings for transforming the source-agnostic data into the corresponding source-specific data.

In some embodiments, data transformation subsystem 112 may be configured to generate source-specific data for each available type of data source 120. For example, for each of canonical-source transformation accelerators 504, a corresponding instance of source-specific data may be generated based on source-agnostic data 606. This can allow data to be generated for a variety of different types of data formatting protocols using the source-agnostic data alone.

In some embodiments, computing system 102 may be configured to generate source-canonical transformation accelerators 502, canonical-source transformation accelerators 504, as well as, or alternatively, one or more additional accelerators. In some embodiments, computing system 102 may generate the source-canonical transformation accelerator by, in some examples, identifying one or more types of metadata stored within sample source-specific data associated with a given one of data sources 120. In one or more examples, the sample source-specific data may be stored within data source database 142. Computing system 102 may be configured to create one or more rules for parsing the source-specific data based on the types of metadata that were identified. In one or more examples, source-canonical transformation accelerators 502 may be configured to store the rules. In some examples, the source-canonical transformation accelerator may store pointers to the rules or to computing systems configured to execute the rules. In this example, at run time, the source-canonical transformation accelerator may cause the rules to be executed.

In some embodiments, computing system 102 may generate canonical-source transformation accelerators 504 be identifying the reverse mappings of each of source-canonical transformation accelerators 502. For example, with reference to FIG. 6B again, a source-canonical transformation accelerator 502 learns to modify the source-specific entity “KNA1” into the source-agnostic entity “CAN_PARTY.” Using this metadata transformation rule, the reverse rule can be determined. For instance, the source-agnostic entity “CAN_PARTY” should transform into the source-specific entity “KNA1” when generating source specific data 202.

In some embodiments, computing system 102 may be further configured to apply one or more data analytics solutions to the source-agnostic data. The data analytics solutions may be executed using a selected cloud-computing service used for the ERP. In one or more examples, the data analytics solutions may include one or more first data analytics solutions, one or more second data analytics solutions, and the like. In one or more examples, the selected cloud-computing service may comprise a first cloud-computing service of a plurality of cloud-computing services, a second cloud-computing service of the plurality of cloud-computing services, and the like. In some embodiments, data transformation subsystem 112 may be configured to apply one or more second data analytics solutions to the source-agnostic data. The second data analytics solutions may be applied to the source-agnostic data in addition to or instead of the first data analytics solutions. In one or more examples, the second data analytics solutions may be executed using a second cloud-computing service used for ERP.

In some embodiments, data transformation subsystem 112 may be configured to generate an interface for providing the one or more data analytics solutions to client device 130. The interface may comprise one or more dashboards providing the end-user analytics in a user-friendly and consumable format.

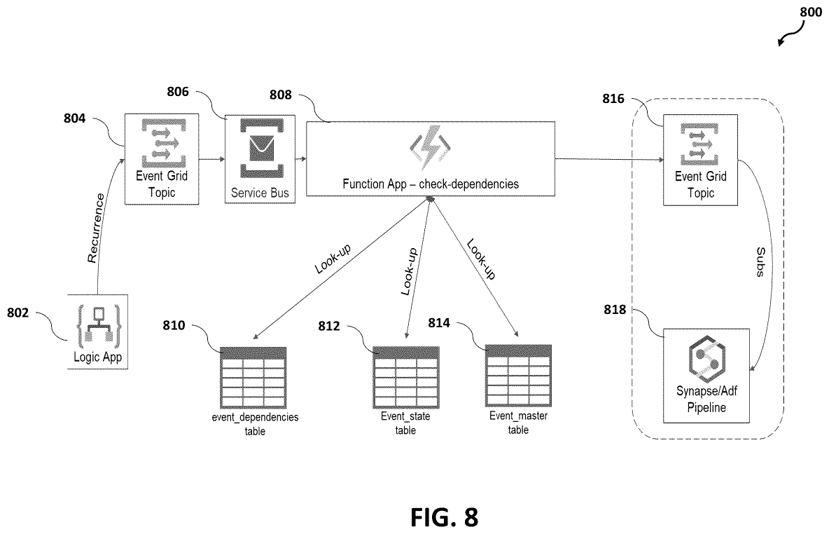

FIG. 8 illustrates an example of an ERP scheduling framework 800, in accordance with various embodiments. In some embodiments, a stateful logic app 802 may be configured to generate time events at a predefined (and optionally configurable) cadence (e.g., every 1 or more minutes, every 5 or more minutes, etc.). Logic app 802 may be configured to send the time events may to an event grid topic 804. In one or more examples, the time events sent to event grid topic 804 may include an “eventType”: “TimeEventCreated” along with an event identifier associated with the time event (e.g., “id”: “TimeEvent-YYYY-MM-DDTXX: XX”). The event identifier may be computed using formula 1 below:

add(div(add(mul(int(convertFromUtc(utcNow( )′Eastern Standard Time′,′HH′)),60), int(convertFr omUtc(utcNow( )′Eastern Standard Time′,′mm′))),15),1) Formula 1.

In some embodiments, event grid topic 804 may be configured to receive the time events from logic app 802 and obtain lists of pipelines to be triggered for that event. For example, a service bus queue of service bus 806 may be subscribed to time events “TimeEventCreated,” and the pipelines event list may be event grid topic after the evaluation of dependences from function app 808 are checked. The pipeline events may have the event type of “TriggerPipeline.” The events may be subscribed to by the datalake layer and the datamart layer.

In some embodiments, function app 808 may be cloud-computing service specific. For example, different cloud-computing services may implement different function apps, however each may be configured to evaluate the dependencies of the pipeline events lists. A list of events may be provided to event grid topic 816 after function app 808 checks the dependencies. In one or more examples, function app 808 may be triggered in response to a message being received by the service bus queue of service bus 806. In some embodiments, function app 808 may be configured to obtain a list of dependencies associated with a given event, a list of dependencies that have already been met, an indication of whether the pipeline belongs to the datalake or datamart (which also can identify whether the transformation accelerator should be a source-canonical transformation accelerator or a canonical-source transformation accelerator). In one or more example, function app 808 may further store an identification key for the source-specific data (e.g., the file, the table).

In some embodiments, ERP scheduling framework 800 may implement two scheduling master pipelines: one for the datalake layer and one for the datamart layer. In one or more examples, the pipelines may be configured to collect a list of events and resolve the event identifiers associated with these events into the data load pipelines.

The datalake layer may be configured to orchestrate a data load therein. To begin, a list of events that were received at event grid topic 816 may be received. The datalake layer data load pipeline may convert the list to an array, which may be looped-over using a “ForEach” activity. In one or more examples, the “ForEach” loop may be obtained using a lookup activity. In one or more examples, the “ForEach” loop may be obtained using a lookup activity. In particular, the pipeline execution details may be gathered based on the lookup activity. For example, a pipeline type flag may be identified from the pipeline execution details. Based on the pipeline type flag, a switch activity may be used to evaluate a pipeline 818 being called.

The datamart layer may be configured to orchestrate a data load therein. To begin, a list of events that were received at event grid topic 816 may be received. The datamart layer data load pipeline may convert this list into an array, which may be looped-over using a “ForEach” activity. In one or more examples, the “ForEach” loop may be obtained using a lookup activity. In particular, the lookup activity may merge event master table 814 to a datamart master table. In some embodiments, the pipeline name may be determined from the lookup activities performed. Based on the pipeline name, a switch statement may be output and evaluated. The switch statement may be configured to execute named pipeline (e.g., pipeline 818) using the parameters returned by the lookup activity. In some embodiments, a pipeline execution status may be stored within event state table 812. Function app 808 may be configured to access event state table 812 to lookup the pipeline execution status.

In some embodiments, the data load scheduling may be implemented using an event scheduling framework, as described above. The data load scheduling may include a first step where one or more load configurations are populated in a datalake (e.g., “tbl_file_master”) or datamart (e.g., “tbl_dm_tbl_master”) layer's master table. Next, an event master table (e.g., event master table 814) may be populated for a corresponding file/table or other source-specific data. Next, the event master table (e.g., “tbl_event_master”) may be populated with details of the data loads depending on the current data load event. After this step, an event dependency table 810 (e.g., “tbl_event_dependencies”) may be populated with one or more pipeline dependencies associated with the data load event. Finally, event dependencies table 810 (e.g., “tbl_event_dependencies”) may be populated with time events for when the data load event(s) should be executed.

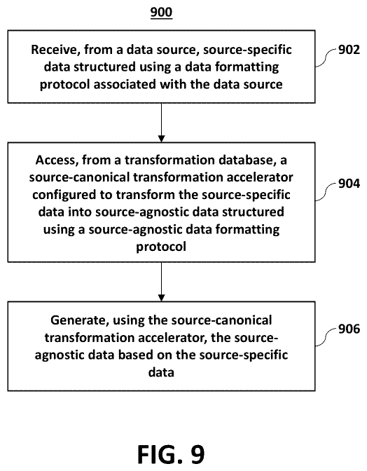

FIG. 9 illustrates a flowchart of an example method 900 for generating source-agnostic data for enterprise resource planning, in accordance with various embodiments. In some embodiments, method 900 may be performed in conjunction with one or more machine learning models executed utilizing one or more processing devices that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), a deep learning processor (DLP), a tensor processing unit (TPU), a neuromorphic processing unit (NPU), or any other processing device(s) that may be suitable for processing user data, reference user data, training data, or other forms of data, and making one or more decisions based thereon), software (e.g., instructions running/executing on one or more processors), firmware (e.g., microcode), or some combination thereof.

In some embodiments, method 900 may begin at step 902. At step 902, source-specific data may be received from a data source. The source-specific data may be structured using a data formatting protocol associated with that data source. In one or more examples, the source-specific data structured may comprise first source specific data structured using a first data formatting protocol associated with a first data source. From the transformation database, a canonical-source transformation accelerator configured to transform the source-agnostic data into second source-specific data structured using a second data formatting protocol associated with a second data source may be accessed. Using the canonical-source transformation accelerator, the second source-specific data may be generated based on the source-agnostic data. In one or more examples, the source-specific data comprises first source-specific data structured using a first data formatting protocol associated with a first data source, and the source-agnostic data comprises first source-agnostic data. From a second data source, second source-specific data structured using a second data formatting protocol associated with the second data source may be received. From the transformation database, a second source-canonical transformation accelerator configured to transform the second source-specific data into second source-agnostic data structured using the source-agnostic data formatting protocol may be accessed. Using the second source-canonical transformation accelerator, the second source-agnostic data may be generated based on the second source-specific data. In some embodiments, step 902 may be performed by a subsystem that is the same or similar to data ingestion subsystem 110.

At step 904, a source-canonical transformation accelerator configured to transform the source-specific data into source-agnostic data structured using a source-agnostic data formatting protocol may be accessed from a transformation database. In one or more examples, the source-canonical transformation accelerator may be configured to execute an extract pipeline, a transformation pipeline, and a load pipeline for each stage of an extract-transform-load (ELT) process. Each of the extract pipeline, the transformation pipeline, and the load pipeline may be controlled by the plurality of metadata tables stored in the transformation database. In some examples, the metadata tables reduce a number of pipelines used by the ERP to a single instance of each of the extract pipeline, the transformation pipeline, and the load pipeline. In one or more examples, the source-canonical transformation accelerator may be generated by identifying one or more types of metadata stored within sample source-specific data associated with the data source and creating one or more rules for parsing the source-specific data based on the one or more types of metadata. The source-canonical transformation accelerator may store the one or more rules. In some embodiments, step 904 may be performed by a subsystem that is the same or similar to data transformation subsystem 112.

At step 906, the source-agnostic data may be generated using the source-canonical transformation accelerator based on the source-specific data. In one or more examples, generating the source-agnostic data comprises generating, using the source-canonical transformation accelerator, the source-agnostic data based on hybrid-based data. The hybrid-based data may be generated based on one or more data quality rules being applied to the source-specific data. Based on the one or more data quality rules indicating that the source-specific data is cleansed, the source-specific data may be stored as hybrid-based data comprising chunks of columns of data sequentially stored. In some embodiments, step 906 may be performed by a subsystem that is the same or similar to data transformation subsystem 112.

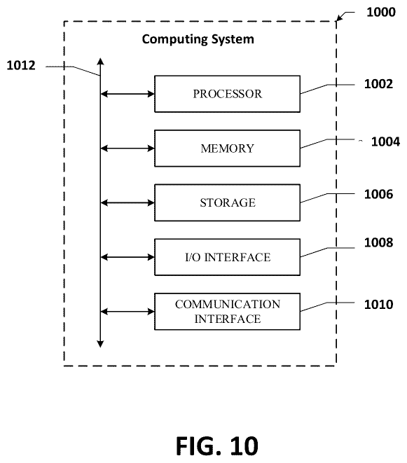

FIG. 10 illustrates an example computer system 1000. In particular embodiments, one or more computer systems 1000 perform one or more steps of one or more methods described or illustrated herein. In particular embodiments, one or more computer systems 1000 provide functionality described or illustrated herein. In particular embodiments, software running on one or more computer systems 1000 performs one or more steps of one or more methods described or illustrated herein or provides functionality described or illustrated herein. Particular embodiments include one or more portions of one or more computer systems 1000. Herein, reference to a computer system may encompass a computing device, and vice versa, where appropriate. Moreover, reference to a computer system may encompass one or more computer systems, where appropriate.

This disclosure contemplates any suitable number of computer systems 1000. This disclosure contemplates computer system 1000 taking any suitable physical form. As example and not by way of limitation, computer system 1000 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1000 may include one or more computer systems 1000; be unitary or distributed; span multiple locations; span multiple machines; span multiple data centers; or reside in a cloud, which may include one or more cloud components in one or more networks. Where appropriate, one or more computer systems 1000 may perform without substantial spatial or temporal limitation one or more steps of one or more methods described or illustrated herein. As an example, and not by way of limitation, one or more computer systems 1000 may perform in real time or in batch mode one or more steps of one or more methods described or illustrated herein. One or more computer systems 1000 may perform at different times or at different locations one or more steps of one or more methods described or illustrated herein, where appropriate.

In particular embodiments, computer system 1000 includes a processor 1002, memory 1004, storage 1006, an input/output (I/O) interface 1008, a communication interface 1010, and a bus 1012. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1002 includes hardware for executing instructions, such as those making up a computer program. As an example, and not by way of limitation, to execute instructions, processor 1002 may retrieve (or fetch) the instructions from an internal register, an internal cache, memory 1004, or storage 1006; decode and execute them; and then write one or more results to an internal register, an internal cache, memory 1004, or storage 1006. In particular embodiments, processor 1002 may include one or more internal caches for data, instructions, or addresses. This disclosure contemplates processor 1002 including any suitable number of any suitable internal caches, where appropriate. As an example, and not by way of limitation, processor 1002 may include one or more instruction caches, one or more data caches, and one or more translation lookaside buffers (TLBs). Instructions in the instruction caches may be copies of instructions in memory 1004 or storage 1006, and the instruction caches may speed up retrieval of those instructions by processor 1002. Data in the data caches may be copies of data in memory 1004 or storage 1006 for instructions executing at processor 1002 to operate on; the results of previous instructions executed at processor 1002 for access by subsequent instructions executing at processor 1002 or for writing to memory 1004 or storage 1006; or other suitable data. The data caches may speed up read or write operations by processor 1002. The TLBs may speed up virtual-address translation for processor 1002. In particular embodiments, processor 1002 may include one or more internal registers for data, instructions, or addresses. This disclosure contemplates processor 1002 including any suitable number of any suitable internal registers, where appropriate. Where appropriate, processor 1002 may include one or more arithmetic logic units (ALUs); be a multi-core processor; or include one or more processors 1002. Although this disclosure describes and illustrates a particular processor, this disclosure contemplates any suitable processor.

In particular embodiments, memory 1004 includes main memory for storing instructions for processor 1002 to execute or data for processor 1002 to operate on. As an example, and not by way of limitation, computer system 1000 may load instructions from storage 1006 or another source (such as, for example, another computer system 1000) to memory 1004. Processor 1002 may then load the instructions from memory 1004 to an internal register or internal cache. To execute the instructions, processor 1002 may retrieve the instructions from the internal register or internal cache and decode them. During or after execution of the instructions, processor 1002 may write one or more results (which may be intermediate or final results) to the internal register or internal cache. Processor 1002 may then write one or more of those results to memory 1004. In particular embodiments, processor 1002 executes only instructions in one or more internal registers or internal caches or in memory 1004 (as opposed to storage 1006 or elsewhere) and operates only on data in one or more internal registers or internal caches or in memory 1004 (as opposed to storage 1006 or elsewhere). One or more memory buses (which may each include an address bus and a data bus) may couple processor 1002 to memory 1004. Bus 1012 may include one or more memory buses, as described below. In particular embodiments, one or more memory management units (MMUs) reside between processor 1002 and memory 1004 and facilitate accesses to memory 1004 requested by processor 1002. In particular embodiments, memory 1004 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1004 may include one or more memories 3404, where appropriate. Although this disclosure describes and illustrates particular memory, this disclosure contemplates any suitable memory.

In particular embodiments, storage 1006 includes mass storage for data or instructions. As an example, and not by way of limitation, storage 1006 may include a hard disk drive (HDD), a floppy disk drive, flash memory, an optical disc, a magneto-optical disc, magnetic tape, or a Universal Serial Bus (USB) drive or a combination of two or more of these. Storage 1006 may include removable or non-removable (or fixed) media, where appropriate. Storage 1006 may be internal or external to computer system 1000, where appropriate. In particular embodiments, storage 1006 is non-volatile, solid-state memory. In particular embodiments, storage 1006 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1006 taking any suitable physical form. Storage 1006 may include one or more storage control units facilitating communication between processor 1002 and storage 1006, where appropriate. Where appropriate, storage 1006 may include one or more storages 3406. Although this disclosure describes and illustrates particular storage, this disclosure contemplates any suitable storage.

In particular embodiments, I/O interface 1008 includes hardware, software, or both, providing one or more interfaces for communication between computer system 1000 and one or more I/O devices. Computer system 1000 may include one or more of these I/O devices, where appropriate. One or more of these I/O devices may enable communication between a person and computer system 1000. As an example, and not by way of limitation, an I/O device may include a keyboard, keypad, microphone, monitor, mouse, printer, scanner, speaker, still camera, stylus, tablet, touch screen, trackball, video camera, another suitable I/O device, or a combination of two or more of these. An I/O device may include one or more sensors. This disclosure contemplates any suitable I/O devices and any suitable I/O interfaces 1008 for them. Where appropriate, I/O interface 1008 may include one or more device or software drivers enabling processor 1002 to drive one or more of these I/O devices. I/O interface 1008 may include one or more I/O interfaces 1008, where appropriate. Although this disclosure describes and illustrates a particular I/O interface, this disclosure contemplates any suitable I/O interface.

In particular embodiments, communication interface 1010 includes hardware, software, or both providing one or more interfaces for communication (such as, for example, packet-based communication) between computer system 1000 and one or more other computer systems 1000 or one or more networks. As an example, and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1010 for it. As an example, and not by way of limitation, computer system 1000 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1000 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1000 may include any suitable communication interface 1010 for any of these networks, where appropriate. Communication interface 1010 may include one or more communication interfaces 1010, where appropriate. Although this disclosure describes and illustrates a particular communication interface, this disclosure contemplates any suitable communication interface.

In particular embodiments, bus 1012 includes hardware, software, or both coupling components of computer system 1000 to each other. As an example and not by way of limitation, bus 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1012 may include one or more buses 1012, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

### Example Embodiments

Embodiments disclosed herein may include:

1. A method for generating source-agnostic data for enterprise resource planning, the method being implemented by one or more processors of a computing system, the method comprising: receiving, from a data source, source-specific data structured using a data formatting protocol associated with the data source; accessing, from a transformation database, a source-canonical transformation accelerator configured to transform the source-specific data into source-agnostic data structured using a source-agnostic data formatting protocol; and generating, using the source-canonical transformation accelerator, the source-agnostic data based on the source-specific data.
2. The method of embodiment 1, wherein the source-specific data structured comprises first source specific data structured using a first data formatting protocol associated with a first data source, the method further comprises: accessing, from the transformation database, a canonical-source transformation accelerator configured to transform the source-agnostic data into second source-specific data structured using a second data formatting protocol associated with a second data source; and generating, using the canonical-source transformation accelerator, the second source-specific data based on the source-agnostic data.
3. The method of embodiment 1 or embodiment 2, wherein the source-specific data comprises first source-specific data structured using a first data formatting protocol associated with a first data source, and wherein the source-agnostic data comprises first source-agnostic data, the method further comprises: receiving, from a second data source, second source-specific data structured using a second data formatting protocol associated with the second data source; accessing, from the transformation database, a second source-canonical transformation accelerator configured to transform the second source-specific data into second source-agnostic data structured using the source-agnostic data formatting protocol; and generating, using the second source-canonical transformation accelerator, the second source-agnostic data based on the second source-specific data.
4. The method of any one of embodiments 1-3, wherein the data source comprises a first data source of a plurality of data sources, wherein each of the plurality of data sources comprises data structured using a corresponding source-specific data formatting protocol.
5. The method of embodiment 4, wherein the plurality of data sources comprises at least ten data sources, at least one hundred data sources, or at least one thousand data sources.
6. The method of any one of embodiments 1-5, wherein receiving the source-specific data comprises: receiving an event notification indicating that the source-specific data is available; and loading the source-specific data into a raw data layer of a cloud-computing service.
7. The method of embodiment 6, wherein the cloud-computing service comprises a first cloud-computing service of a plurality of cloud-computing services each having a different infrastructure.
8. The method of embodiment 6 or embodiment 7, further comprising: executing a set of metadata classification rules to the source-specific data to identify one or more types of metadata within the source-specific data, wherein the set of metadata classification rules attribute a value to each of the one or more types of metadata based on the source-specific data.
9. The method of embodiment 8, further comprising: applying one or more data quality rules to the source-specific data; and storing, based on the one or more data quality rules indicating that the source-specific data is cleansed, the source-specific data as hybrid-based data comprises chunks of columns of data sequentially stored.
10. The method of embodiment 9, wherein each chunk of columns comprises values for each of the one or more types of metadata.
11. The method of embodiment 9, wherein generating the source-agnostic data comprises: generating, using the source-canonical transformation accelerator, the source-agnostic data based on the hybrid-based data.
12. The method of any one of embodiments 1-11, further comprising: applying one or more data analytics solutions to the source-agnostic data, wherein the one or more data analytics solutions are executing using a selected cloud-computing service used for the enterprise resource planning.
13. The method of embodiment 12, further comprising: generating an interface for providing the one or more data analytics solutions to a client device.
14. The method of embodiment 12 or embodiment 13, wherein the one or more data analytics solutions comprise one or more first data analytics solutions, and the selected cloud-computing service comprises a first cloud-computing service of a plurality of cloud-computing services, the method further comprises: applying one or more second data analytics solutions to the source-agnostic data, wherein the one or more second data analytics solutions are executing using a second cloud-computing service used for ERP.
15. The method of any one of embodiments 1-14, wherein the transformation database comprises a plurality of metadata tables storing one or more data schemas, one or more transformation rules, one or more control parameters, and error-handling logic.
16. The method of embodiment 15, wherein the source-canonical transformation accelerator is configured to execute an extract pipeline, a transformation pipeline, and a load pipeline for each stage of an extract-transform-load (ELT) process, wherein each of the extract pipeline, the transformation pipeline, and the load pipeline are controlled by the plurality of metadata tables stored in the transformation database.
17. The method of embodiment 16, wherein the plurality of metadata tables reduce a number of pipelines used by the ERP to a single instance of each of the extract pipeline, the transformation pipeline, and the load pipeline.
18. The method of any one of embodiments 1-17, further comprising: generating the source-canonical transformation accelerator, comprising: identifying one or more types of metadata stored within sample source-specific data associated with the data source; and creating one or more rules for parsing the source-specific data based on the one or more types of metadata, wherein the source-canonical transformation accelerator stores the one or more rules.
19. A system used to implement an enterprise resource planning (ERP) framework, the system comprising: a plurality of sources each storing source-specific data; a transformation database storing one or more transformation accelerators for transforming source-specific data into source-agnostic data; and a data transformation engine configured to perform the method of any one of embodiments 1-18.
20. A non-transitory computer-readable medium storing computer program instructions that, when executed by one or more processors of a computing system, effectuate operations comprising the method of any one of embodiments 1-18.

1. A method for generating source-agnostic data for enterprise resource planning, the method being implemented by one or more processors of a computing system, the method comprising:
receiving, from a data source, source-specific data structured using a data formatting protocol associated with the data source;
accessing, from a transformation database, a source-canonical transformation accelerator configured to transform the source-specific data into source-agnostic data structured using a source-agnostic data formatting protocol; and
generating, using the source-canonical transformation accelerator, the source-agnostic data based on the source-specific data.

2. The method of claim 1, wherein the source-specific data structured comprises first source specific data structured using a first data formatting protocol associated with a first data source, the method further comprises:
accessing, from the transformation database, a canonical-source transformation accelerator configured to transform the source-agnostic data into second source-specific data structured using a second data formatting protocol associated with a second data source; and
generating, using the canonical-source transformation accelerator, the second source-specific data based on the source-agnostic data.

3. The method of claim 1, wherein the source-specific data comprises first source-specific data structured using a first data formatting protocol associated with a first data source, and wherein the source-agnostic data comprises first source-agnostic data, the method further comprises:
receiving, from a second data source, second source-specific data structured using a second data formatting protocol associated with the second data source;
accessing, from the transformation database, a second source-canonical transformation accelerator configured to transform the second source-specific data into second source-agnostic data structured using the source-agnostic data formatting protocol; and
generating, using the second source-canonical transformation accelerator, the second source-agnostic data based on the second source-specific data.

4. The method of claim 1, wherein the data source comprises a first data source of a plurality of data sources, wherein each of the plurality of data sources comprises data structured using a corresponding source-specific data formatting protocol.

5. The method of claim 4, wherein the plurality of data sources comprises at least ten data sources, at least one hundred data sources, or at least one thousand data sources.

6. The method of claim 1, wherein receiving the source-specific data comprises:
receiving an event notification indicating that the source-specific data is available; and
loading the source-specific data into a raw data layer of a cloud-computing service.

7. The method of claim 6, wherein the cloud-computing service comprises a first cloud-computing service of a plurality of cloud-computing services each having a different infrastructure.

8. The method of claim 6, further comprising:
executing a set of metadata classification rules to the source-specific data to identify one or more types of metadata within the source-specific data, wherein the set of metadata classification rules attribute a value to each of the one or more types of metadata based on the source-specific data.

9. The method of claim 8, further comprising:
applying one or more data quality rules to the source-specific data; and
storing, based on the one or more data quality rules indicating that the source-specific data is cleansed, the source-specific data as hybrid-based data comprises chunks of columns of data sequentially stored.

10. The method of claim 9, wherein each chunk of columns comprises values for each of the one or more types of metadata.

11. The method of claim 9, wherein generating the source-agnostic data comprises:
generating, using the source-canonical transformation accelerator, the source-agnostic data based on the hybrid-based data.

12. The method of claim 1, further comprising:
applying one or more data analytics solutions to the source-agnostic data, wherein the one or more data analytics solutions are executing using a selected cloud-computing service used for the enterprise resource planning.

13. The method of claim 12, further comprising:
generating an interface for providing the one or more data analytics solutions to a client device.

14. The method of claim 12, wherein the one or more data analytics solutions comprise one or more first data analytics solutions, and the selected cloud-computing service comprises a first cloud-computing service of a plurality of cloud-computing services, the method further comprises:
applying one or more second data analytics solutions to the source-agnostic data, wherein the one or more second data analytics solutions are executing using a second cloud-computing service used for ERP.

15. The method of claim 1, wherein the transformation database comprises a plurality of metadata tables storing one or more data schemas, one or more transformation rules, one or more control parameters, and error-handling logic.

16. The method of claim 15, wherein the source-canonical transformation accelerator is configured to execute an extract pipeline, a transformation pipeline, and a load pipeline for each stage of an extract-transform-load (ELT) process, wherein each of the extract pipeline, the transformation pipeline, and the load pipeline are controlled by the plurality of metadata tables stored in the transformation database.

17. The method of claim 16, wherein the plurality of metadata tables reduce a number of pipelines used by the ERP to a single instance of each of the extract pipeline, the transformation pipeline, and the load pipeline.

18. The method of claim 1, further comprising:
generating the source-canonical transformation accelerator, comprising:
identifying one or more types of metadata stored within sample source-specific data associated with the data source; and
creating one or more rules for parsing the source-specific data based on the one or more types of metadata, wherein the source-canonical transformation accelerator stores the one or more rules.

19. A system used to implement an enterprise resource planning (ERP) framework, the system comprising:
a plurality of sources each storing source-specific data;
a transformation database storing one or more transformation accelerators for transforming source-specific data into source-agnostic data; and
a data transformation engine configured to:
receive, from a data source, the source-specific data structured using a data formatting protocol associated with the data source;
access, from the transformation database, a source-canonical transformation accelerator configured to transform the source-specific data structured using the data formatted protocol associated with the data source to the source-agnostic data structured using a source-agnostic data formatting protocol; and
generating, using the source-canonical transformation accelerator, the source-agnostic data based on the source-specific data.

20. A non-transitory computer-readable medium storing computer program instructions that, when executed by one or more processors of a computing system, effectuate operations comprising:
receiving, from a data source, source-specific data structured using a data formatting protocol associated with the data source;
accessing, from a transformation database, a source-canonical transformation accelerator configured to transform the source-specific data structured using the data formatting protocol associated with the data source to source-agnostic data structured using a source-agnostic data formatting protocol; and
generating, using the source-canonical transformation accelerator, the source-agnostic data based on the source-specific data.
